(19) United States
(12) Patent Application Publication
(10) Pub. No.: US 2008/0081108 A1
(43) Pub. Date: Apr. 3, 2008

(54) METHOD AND APPARATUS FOR FORMING OPTICAL FILM, AND OPTICAL ARTICLE

(75) Inventors: Kazuhiro YAMADA, Saitama (JP); Yasuhiro SAKAI, Saitama (JP); Hiroyuki NAKAYAMA, Tokyo (JP); Maki YAMADA, Saitama (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/865,120

(22) Filed: Oct. 1, 2007

(30) Foreign Application Priority Data
Oct. 2, 2006 (JP) 2006-271063
Oct. 2, 2006 (JP) 2006-271064

(51) Int. Cl. B05D 7/00; B05B 13/02; B05C 11/02; B05C 5/02

(52) U.S. Cl. 427/164; 118/52

(57) ABSTRACT

An apparatus for forming an optical film on a curved-surface, optically effective portion of a pickup lens having the optically effective portion and a circumferential flange, comprising a rotatable jig for fixedly holding the pickup lens, an apparatus for rotating the jig, a case rotatably supporting the jig, and a nozzle for spraying or dropping a coating solution containing an optical-film-forming component onto the pickup lens; the jig comprising a columnar table and a hollow cylindrical cover, the hollow cylindrical cover comprising tabs extending inward from an upper end of a cylindrical portion for fixedly holding the flange, and the coating solution being sprayed or dropped onto the optically effective portion, while rotating the jig at a rotation speed of 8,000 rpm or more with the deviation of rotation axis of 50 μm or less.

### FIELD OF THE INVENTION

The present invention relates to a method and apparatus for forming a uniform optical film on an optical substrate having a large inclination angle, such as a pickup lens, etc. with good reproducibility, and an optical article having such optical film.

### BACKGROUND OF THE INVENTION

To form optical films such as ant-reflection films, etc., physical vapor deposition methods such as a vapor deposition method, a sputtering method, an ion plating method, etc. have conventionally been used. However, the physical vapor deposition methods are disadvantageous in high cost because they are performed in vacuum. Accordingly, wet coating methods such as a dipping method, a spin-coating method, a spray-coating method, etc. utilizing a sol-gel reaction are used on lenses, flat panel displays, etc. However, the dipping method is likely to cause uneven thickness, and has difficulty in forming thin films of less than 1 μm. The spin-coating method and the spray-coating method are advantageous in forming relatively uniform optical films.

For instance, U.S. Pat. No. 5,208,847 discloses a method for producing an ultra-thin polymer film having a thickness of 10-1,000 Å useful for optical elements such as optical waveguides, etc., which comprises dropping a solution containing 0.1-20 mg/mL of a crotonate polymer onto an optical glass substrate, and forming a thin film by a spin-coating method at 1,000-15,000 rpm.

JP 6-246220 A discloses a lens-surface-treating method free from appearance defects due to the scattering and foaming of a hard coat solution on a lens surface, and also free from the contamination of an apparatus by a hard coat solution attached to a lens-fixing member, a nozzle orifice, etc. This method comprises coating a hard coat solution while rotating the lens around an axis slanting from the vertical line.

Japanese Utility Model Registration 3052152 discloses an apparatus for uniformly spray-coating a resin solution containing a coloring agent to an inner surface of a bowl-shaped cover glass for a side-marker lamp of an automobile, which comprises a rotating dish plate supporting the cover glass with its opening downward, a gun disposed under the dish plate for spraying the resin solution to the inner surface of the rotating bowl-shaped cover glass, and an apparatus for adjusting the position and angle of the gun.

JP 2000-140745 A discloses a method for forming a flat coating layer, which comprises spraying a hard coat solution to an optical substrate, and rotating the optical substrate at 500-3,000 rpm.

However, any wet coating methods described in U.S. Pat. No. 5,209,847, JP 6-246220 A, Japanese Utility Model Registration 3052152 and JP 2000-140745 A are poorer in thickness controllability than the physical vapor deposition method. Accordingly, they have difficulty in forming a uniformly optical film on an optical substrate having a high numerical aperture (NA) and a large inclination angle, such as a pickup lens for apparatuses for recording and reproducing optical information, with good reproducibility.

JP 2000-33301 A discloses a method for forming a uniform optical film on a lens. This method comprises measuring the thickness distribution of a coating agent sprayed onto a rotating lens from a fixed nozzle, adjusting the nozzle such that the thickness distribution meets predetermined conditions, and spraying the coating agent onto the rotating lens. However, when an optical film is formed on a pickup lens having an extremely small diameter of about 5 mm and a large curvature, only the adjustment of the nozzle would be insufficient to provide the optical film with uniform thickness distribution.

### OBJECTS OF THE INVENTION

Accordingly, an object of the present invention is to provide a method for forming a uniform optical film on an optical substrate having a large inclination angle with good reproducibility.

Another object of the present invention is to provide an apparatus for forming a uniform optical film on an optical substrate having a large inclination angle with good reproducibility.

A further object of the present invention is to provide an optical article having such optical film.

### DISCLOSURE OF THE INVENTION

As a result of intense research in view of the above objects, the inventors have found that an optical film having excellent uniformity can be formed with good reproducibility, by using a rotatable jig for fixedly holding an optical substrate, and by spraying or dropping a coating solution containing an optical-film-forming component onto an optical substrate, while rotating the jig at a rotation speed of 8,000 rpm or more with the deviation of rotation axis of 50 μm or less. The present invention has been completed based on such finding.

Thus, the method of the present invention for forming an optical film on an optical substrate comprises fixing the optical substrate to a rotatable jig, and spraying or dropping a coating solution containing an optical-film-forming component onto the optical substrate while rotating the jig, the rotation speed of the jig being 8,000 rpm or more, and the deviation of rotation axis of the jig being kept within 50 μm.

The rotation speed precision of the jig (deviation of rotation speed) is preferably kept within ±0.05%.

Using a nozzle communicating to a carrier gas reservoir and a coating solution tank, a high-pressure carrier gas is sent to the nozzle from the carrier gas reservoir to supply the coating solution from the tank to the nozzle by negative-pressure suction, thereby spraying the coating solution from the nozzle. The amount of the coating solution ejected is preferably 1-10 mL/minute, the variation of the amount of the coating solution ejected is preferably 0.1 mL/minute or less, and the amount of the carrier gas ejected is preferably 1-10 L/minute.

With pluralities of jigs in one unit, the nozzle spraying the coating solution moves along a line passing over all optical substrates. In this case, the moving speed of the nozzle is preferably 10-2,000 mm/second.

The coating solution preferably has such a concentration as to have a viscosity of 20 cP or less.

The step of spraying or dropping the coating solution onto the optical substrate is preferably repeated plural times.

The optical substrate is preferably a pickup lens.

The optical article of the present invention preferably comprises the optical film formed by the above method.

The apparatus of the present invention for forming an optical film on an optical substrate comprises a rotatable jig for fixedly holding the optical substrate, an apparatus for rotating the jig, and a nozzle for spraying or dropping a coating solution containing an optical-film-forming component onto the optical substrate, the rotation speed of the jig being 8,000 rpm or more, and the deviation of rotation axis of the jig being 50 μm or less. The rotation speed precision of the jig rotating at 8,000 rpm or more is preferably within ±0.05%.

The apparatus of the present invention for forming an optical film on a curved-surface, optically effective portion of a pickup lens having the optically effective portion and a circumferential flange, comprises a rotatable jig for fixedly holding the pickup lens, an apparatus for rotating the jig, a case rotatably supporting the jig, and a nozzle for spraying or dropping a coating solution containing an optical-film-forming component onto the pickup lens; the jig comprising a columnar table for supporting the pickup lens at a rotation center, and a hollow cylindrical cover attached to the columnar table; the hollow cylindrical cover comprising a cylindrical portion, and tabs extending inward from an upper end of the cylindrical portion for fixedly holding the flange; and the coating solution being sprayed or dropped onto the optically effective portion, while rotating the jig at a rotation speed of 8,000 rpm or more with the deviation of rotation axis of 50 μm or less.

The jig may comprise a doughnut-shaped plate between the flange and the tabs.

The hollow cylindrical cover is preferably screwed to the columnar table.

It is preferable that the case rotatably supports pluralities of jigs, and that the apparatus comprises an apparatus for moving the nozzle over all pickup lenses.

### BRIEF DESCRIPTION OF THE DRAWINGS

FIG. 1 is a cross-sectional view showing one example of pickup lenses, on which an optical film is formed.

FIG. 2 is a partially cut-off perspective view showing an optical-film-forming apparatus according to one embodiment of the present invention.

FIG. 3(a) is a vertical cross-sectional view showing a rotatable jig unit.

FIG. 3(b) is a plan view showing the rotatable jig unit of FIG. 3(a), with an upper wall of a case omitted.

FIG. 4(a) is a plan view showing a rotatable jig fixedly holding a pickup lens.

FIG. 4(b) is a cross-sectional view taken along the line A-A in FIG. 4(a).

FIG. 5(a) is a plan view showing another example of rotatable jigs.

FIG. 5(b) is a cross-sectional view taken along the line B-B in FIG. 5(a).

FIG. 6 is a cross-sectional view showing a further example of rotatable jigs.

FIG. 7 is a cross-sectional view showing a still further example of rotatable jigs.

FIG. 8 is a cross-sectional view showing a still further example of rotatable jigs.

FIG. 9 is a schematic view showing a coating apparatus in the optical-film-forming apparatus.

FIG. 10 is a partial enlarged view showing the coating apparatus.

FIG. 11 is a schematic view showing one example of nozzle-moving methods.

FIG. 12 is a schematic view showing a coating apparatus used in the second optical-film-forming apparatus.

FIG. 13(a) is a vertical cross-sectional view showing a coating solution applied to a rotating lens under conditions outside the present invention.

FIG. 13(b) is a cross-sectional view taken along the line C-C in FIG. 13(a).

FIG. 14(a) is a vertical cross-sectional view showing a coating solution applied to a rotating lens under conditions within the present invention.

FIG. 14(b) is a cross-sectional view taken along the line D-D in FIG. 14(a).

### DESCRIPTION OF THE PREFERRED EMBODIMENTS

Each embodiment of the present invention will be explained referring to the attached drawings, and explanations made in each embodiment are applicable to other embodiments unless otherwise mentioned.

[1] Optical Substrate

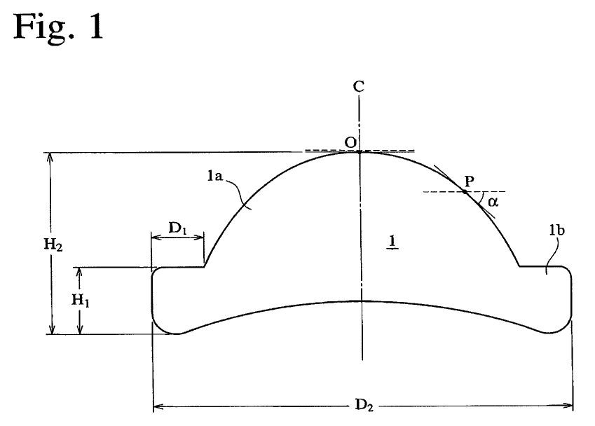

The optical substrate on which an optical film is formed may be a relatively small-sized lens with a large inclination angle, for instance, a pickup lens 1 shown in FIG. 1, which is used in apparatuses for recording and reproducing optical information, though not restrictive. The pickup lens 1 has a flange 1b on a periphery of an optically effective portion 1a. An inclination angle α at a point P on a surface of the optically effective portion 1a, which is an angle between a tangent line at the point P and a line perpendicular to a center axis C of the pickup lens 1, is 0° at a center O of the pickup lens 1, and increases as separating from the center O.

The materials for the pickup lens 1 are preferably glass or plastics. Specific examples of glass include BK7, F2, SF1, etc., and specific examples of plastics include acrylic resins, polycarbonates, polyolefins, etc.

[2] Optical-Film-Forming Apparatus

Taking for example a case where the optical substrate 1 is a pickup lens (hereinafter called simply “lens” unless otherwise mentioned), the optical-film-forming apparatus of the present invention will be explained in detail below.

(A) First Apparatus

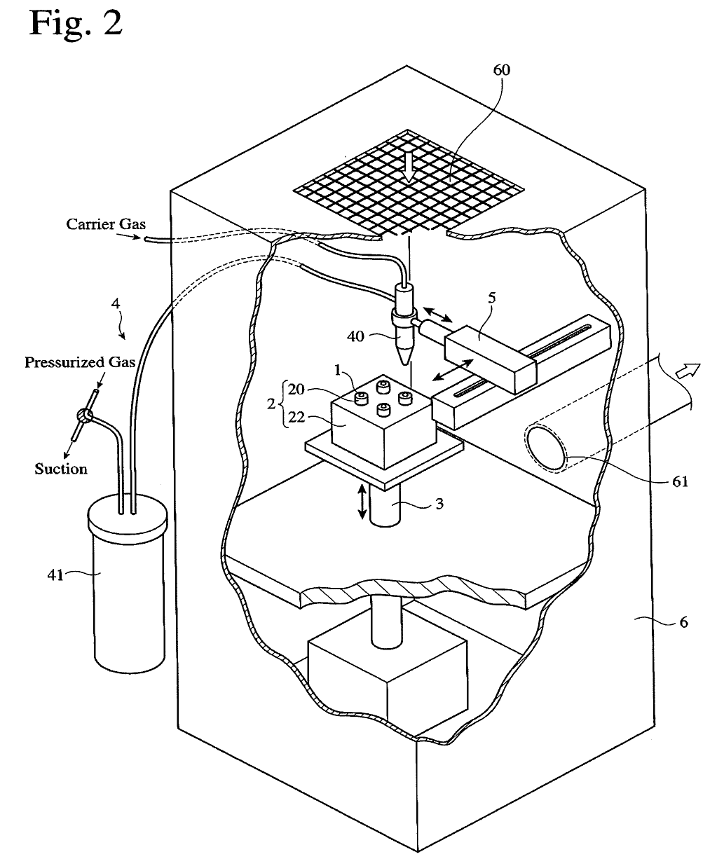

FIG. 2 shows the first optical-film-forming apparatus of the present invention. This apparatus comprises (a) a rotatable jig unit 2 comprising a rotatable jig 20 for fixedly holding the lens 1, (b) an elevating apparatus 3 for supporting the rotatable jig unit 2, (c) a coating apparatus 4 comprising a nozzle 40 disposed above the lens 1, and a tank 41 supplying a coating solution to the nozzle 40, (d) a moving apparatus 5 which two-dimensionally or three-dimensionally moves the nozzle 40 relative to the lens 1, and (e) a casing 6 containing the rotatable jig unit 2, the elevating apparatus 3, the nozzle 40, and the nozzle-moving apparatus 5. The casing 6 has an air inlet 60 in an upper wall and an air outlet 61 in a rear wall, to prevent a mist of the coating solution 13 ejected from the nozzle 40 from filling the casing 6 and attaching to portions other than the lens 1.

(1) Rotatable Jig Unit

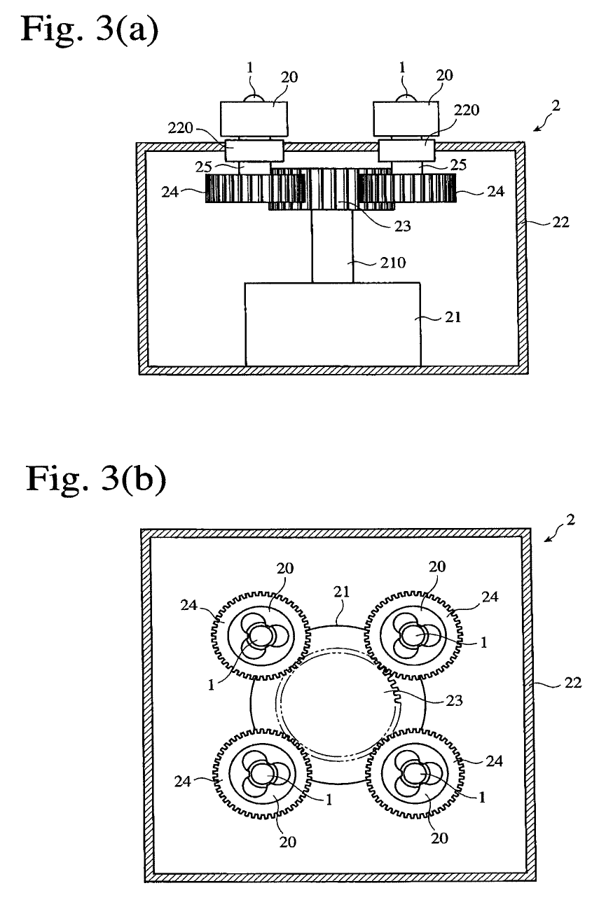

As shown in FIGS. 3(a) and 3(b), the rotatable jig unit 2 comprises a case 22 having bearings 220, a motor 21 contained in the case 22, a gear 23 fixed to a tip end portion of a shaft 210 of the motor 21, pluralities of gears 24 engageable with the gear 23, and a rotatable jig 20 having a shaft 25 having a lower end portion to which each gear 24 is fixed, the shaft 25 being rotatably supported by the bearing 220 such that the jig 20 stands vertical. The jig 20 has a mechanism of fixedly holding the lens 1 without wobbling. There are four jigs 20 in this example, though the number of the jigs 20 is not restrictive. The jig 20 is rotated by the motor 21 via a drive mechanism comprising gears 23, 24. The drive mechanism may use a belt.

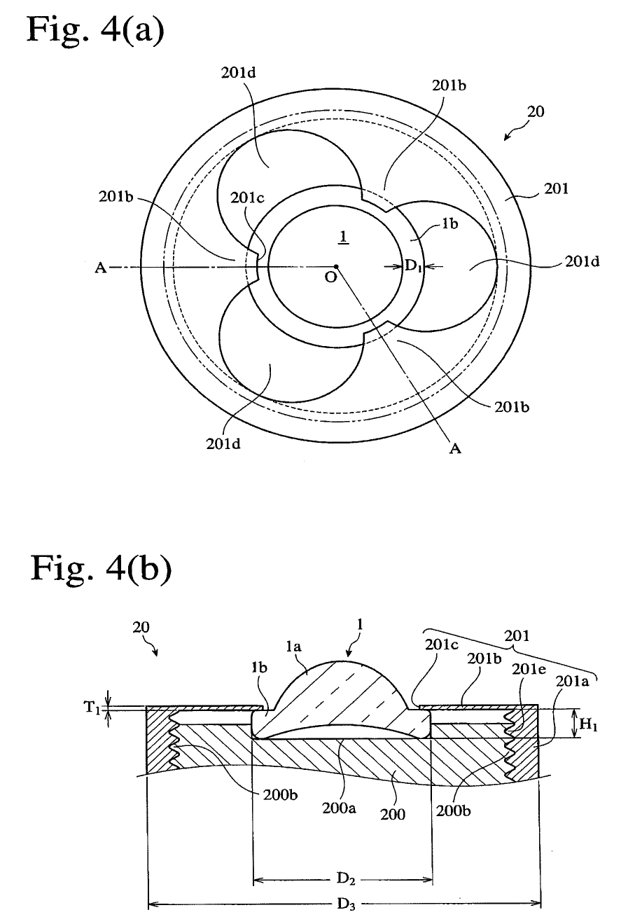

Because the jig 20 should firmly hold the lens 1 rotating at a high speed of 8,000 rpm or more without displacement, as shown in FIGS. 4(a) and 4(b), it comprises a columnar table 200 having a circular recess 200a for receiving the lens 1 on an upper surface and a threaded portion 200b on a side surface, and a hollow cylindrical cover 201 threaded to the table 200 for holding the lens 1. The circular recess 200a has a diameter and a depth precisely positioning the lens 1.

The hollow cylindrical cover 201 comprises a cylindrical portion 201a having on an inner surface a threaded portion 201e threadably engageable with the threaded portion 200b of the table 200, and pluralities of tabs 201b extending inward from an upper end of the cylindrical portion 201a. The number of tabs 201b is three in this example, though not restrictive. Each tab 201b is tapered, with its inside end 201c positioned on an upper surface of the flange 1b of the lens 1. With the center axis C of the lens 1 as a center, the position of the inside end 201c of the tab 201b is preferably in a range of 20-80%, more preferably in a range of 30-60%, of the width D₁ of the flange 1b from a periphery of the flange 1b. When the inside end 201c is disposed at a position of less than 20% of D₁ from the periphery of the flange 1b, the tab 201b cannot sufficiently firmly hold the lens 1. On the other hand, when the position of the inside end 201c is more than 80% of D₁ from the periphery of the flange 1b, it is difficult to form an optical film uniformly on a peripheral portion of the optically effective portion 1a close to the flange 1b. Though not particularly restricted, the outer diameter D₃ of the hollow cylindrical cover 201 may be about 1.5-4 times the outer diameter D₂ of the lens 1.

Because each tab 201b is tapered, there is a space 201d between adjacent tabs 201b, 201b, in which the flange 1b of the lens 1 is exposed. Because the tapered tab 201b has a resiliently deformable tip end portion, it can resiliently push and fix the flange 1b. Accordingly, an excess force is not applied to the flange 1b when fixed by the tab 201b. To fix the flange 1b while preventing its damage, the thickness T₁ of the tab 201b is preferably 2-10% of the thickness H₁ of the flange 1b.

Because the hollow cylindrical cover 201 has a space 201d, the coating solution 13 gathering in a peripheral portion of the optically effective portion 1a close to the flange 1b can be scattered by a centrifugal force by high-speed rotation, thereby forming a uniform optical film.

When the jig 20 is rotated at 8,000 rpm or more, the deviation of rotation axis of the jig 20 should be 50 μm or less. When the deviation of rotation axis of the jig 20 is more than 50 μm, a non-uniform optical film is obtained. The deviation of rotation axis of the jig 20 is preferably 40 μm or less, more preferably 30 μm or less. The deviation of rotation axis of the jig 20 can be determined by measuring the displacement of the side surface of the rotating jig 20 fixedly holding the lens 1 by a non-contact laser displacement meter (not shown) disposed by the jig 20. Measurement is conducted three times, and the maximum among the measured values is used as the deviation of rotation axis. To enable high-speed rotation with small deviation of rotation axis, the bearing 220 rotatably supporting the jig 20 should have high precision.

When the jig 20 is rotated at 8,000 rpm or more, a rotation speed precision is preferably within ±0.05%. When the rotation speed precision exceeds ±0.05%, the resultant optical film is likely to be non-uniform. The rotation speed precision is more preferably ±0.02% or less. The rotation speed precision of the rotatable jig 20 is determined by monitoring an output signal from an encoder directly connected to the motor 21.

Specific examples of the motor 21 having such high rotation speed precision include spindle motors for driving hard disks, CDs, DVDs, etc. Preferred materials for the columnar table 200 and the hollow cylindrical cover 201 include various metals such as alloyed steel, stainless steel, aluminum, etc.

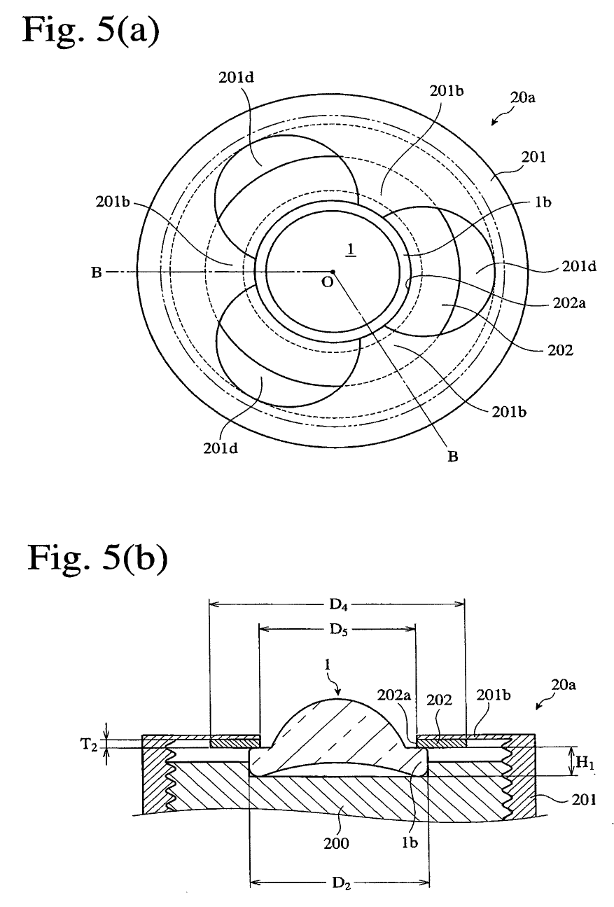

The rotatable jig 20a shown in FIGS. 5(a) and 5(b) is the same as the rotatable jig 20 shown in FIG. 4 except for comprising a doughnut-shaped plate 202 between a columnar table 200 and a hollow cylindrical cover 201. The doughnut-shaped plate 202 is in contact with the flange 1b of the lens 1 in its entire periphery, and the tab 201b pushes the doughnut-shaped plate 202. In this example, the outer diameter D₄ of the doughnut-shaped plate 202 is larger than the outer diameter D₂ of the lens 1. The inner diameter D₅ of the doughnut-shaped plate 202 is aligned with the position of the inside end 201c of the tab 201b, though not restrictive, of course.

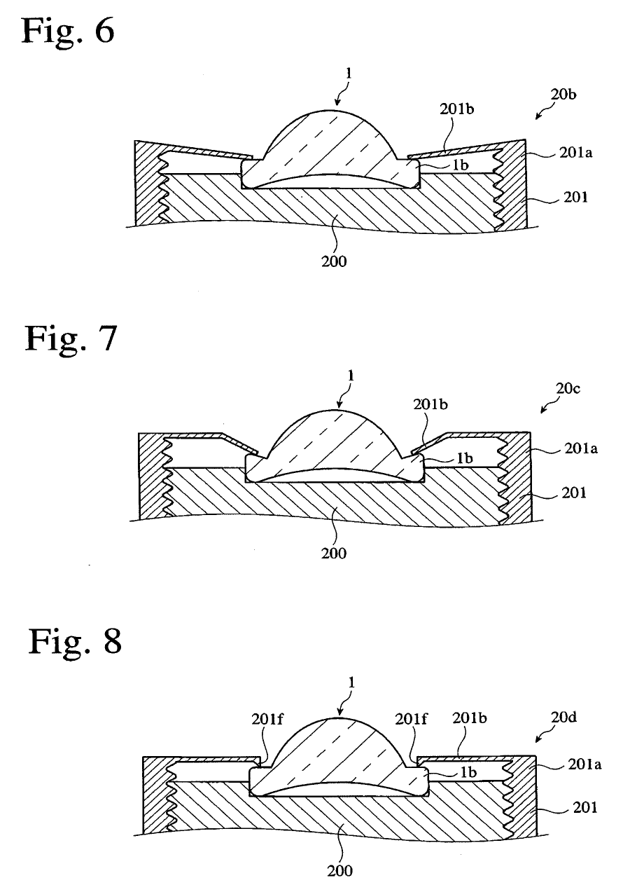

The jig 20b shown in FIG. 6 is the same as the rotatable jig 20 shown in FIG. 4 except that a tab 201b is inclined downward. Downward inclination increases the pushing force of the tab 201b.

The jig 20c shown in FIG. 7 is the same as the rotatable jig 20b shown in FIG. 6 except that a tab 201b is bent halfway so that its tip end portion is inclined downward. This tab 201b also exerts a large pushing force to the flange 1b of the lens 1.

The jig 20d shown in FIG. 8 is the same as the rotatable jig 20 shown in FIG. 4 except that a tab 201b has a nail-like downward projection 201f at its inside end 201c. An upper surface of the flange 1b of the lens 1 may have an annular groove for receiving the downward projection 201f, if necessary.

(2) Coating Apparatus

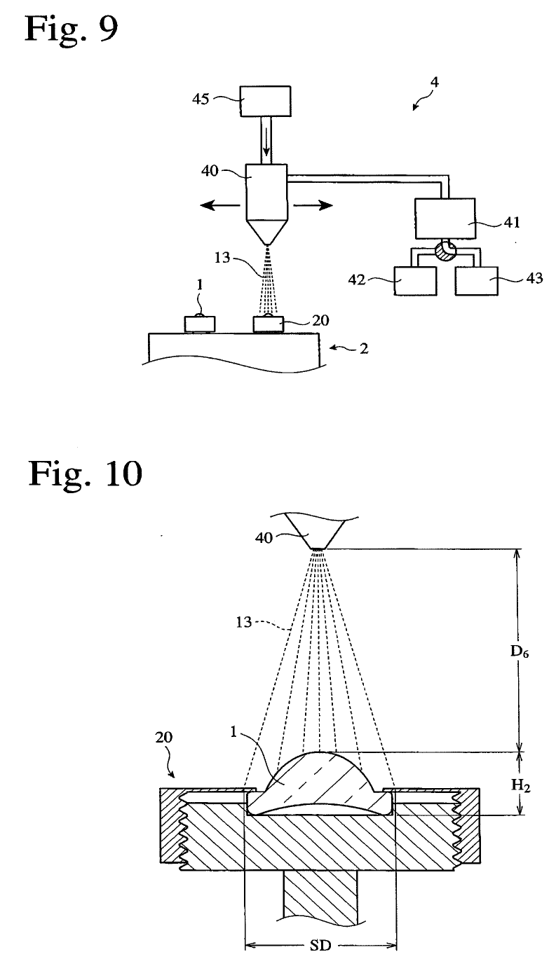

As shown in FIG. 9, the apparatus 4 for coating the lens 1 comprises a tank 41 of a coating solution 13, a evacuating apparatus 42 which evacuates the tank 41, a pressurizing apparatus 43 which supplies pressurized gas to the tank 41, a nozzle 40 connected to the tank 41, and a compressor 45 supplying a carrier gas to the nozzle 40 in an axial direction, to spray the coating solution 13 together with the carrier gas from the nozzle 40. The carrier gas is preferably an inert gas not reactive with the coating solution 13. To prevent the coating solution 13 from attaching to a tip end of the nozzle 40, the nozzle 40 may have a concentric double-pipe structure comprising an inner pipe for ejecting the coating solution 13 and an outer pipe for ejecting the carrier gas. The details of such nozzle 40 are described in JP 2005-292478 A.

(B) Second Apparatus

FIG. 12 shows the second optical-film-forming apparatus of the present invention. This apparatus is the same as the first apparatus except for comprising a coating apparatus 4′ comprising a pump 46 for supplying a coating solution 13 from a tank 41. The flow rate of the coating solution 13 ejected from the nozzle 40 is adjusted by controlling the pump 46 by a program-stored controller 47. The pump 46 is preferably a plunger pump. In the second apparatus, the coating solution 13 is dropped onto the lens 1.

[3] Formation of Optical Film

Because any one of the first and second apparatuses may be used to form the optical film, detailed explanation will be made below using the first apparatus.

(1) Preparation of Coating Solution

An optical-film-forming component and a solvent are mixed to prepare the coating solution 13. Usable as the optical-film-forming component are metal alkoxides, ultraviolet-curing resins, heat-setting resins, and composites of inorganic particles and binders. When the optical-film-forming component is metal alkoxide, a catalyst is added to the coating solution. Preferred solvents are volatile solvents dissolving the optical-film-forming component, specifically alcohols, glycols, ketones, esters, fluorinated hydrocarbons, fluorinated ethers (for instance, perfluoroethers), etc.

The viscosity of the coating solution 13 is preferably 20 cP or less, more preferably 5 cP or less. When the viscosity of the coating solution 13 exceeds 20 cP, it is difficult to form a uniform optical film on the lens 1. To achieve such viscosity, the optical-film-forming component preferably has a concentration of 20% by mass or less.

(2) Supply of Coating Solution to Nozzle

After negative pressure inside the tank 41 is provided by the evacuating apparatus 42, pressure inside the tank 41 is adjusted by the pressurizing apparatus 43, to control the flow rate of the coating solution 13 supplied to the nozzle 40 by negative-pressure suction. The flow rate of a high-pressure gas supplied to the tank 41 from the pressurizing apparatus 43 is controlled by a mass-flow controller, for instance.

(3) Rotation of Lens and Coating

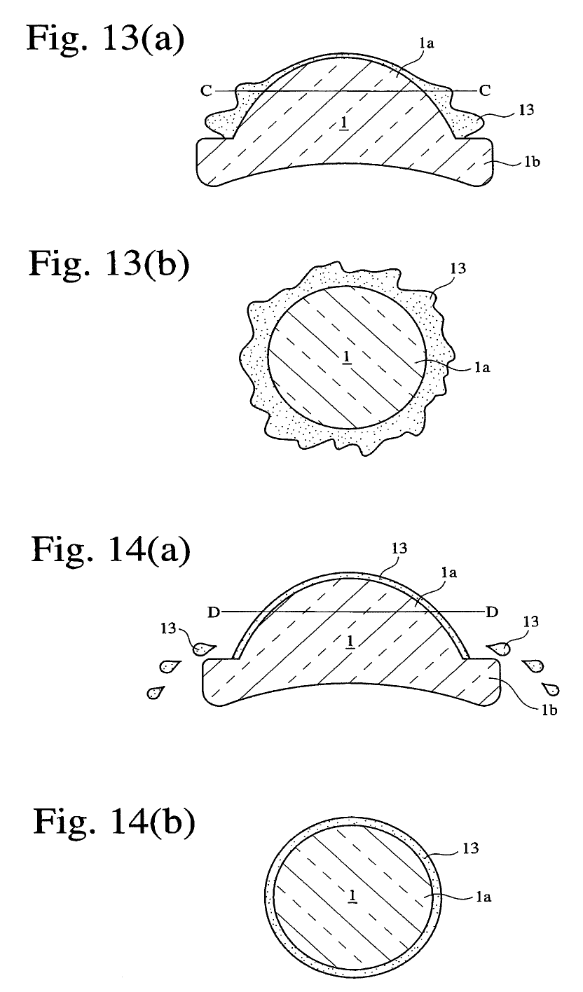

The jig 20 fixedly holding the lens 1 is rotated at a constant speed of 8,000 rpm or more. When the rotation speed of the jig 20 is less than 8,000 rpm, as shown in FIGS. 13(a) and 13(b), the coating solution 13 predominantly exists in a peripheral portion of the optically effective portion 1a of the rotating lens 1, resulting in unevenness in the coating solution 13 in a circumferential direction. When the rotation speed is increased to 8,000 rpm or more, as shown in FIGS. 14(a) and 14(b), the coating solution 13 existing in a peripheral portion of the optically effective portion 1a is scattered by a large centrifugal force. As a result, unevenness is suppressed in the coating solution 13 in a circumferential direction. The rotation speed of the jig 20 is preferably 9,000 rpm or more, more preferably 9,500 rpm or more. A practical upper limit of the rotation speed of the jig 20 is about 15,000 rpm.

Even if the rotation speed is 8,000 rpm or more, however, the deviation of rotation axis of more than 50 μm provides large unevenness to the coating solution 13. Accordingly, to obtain a uniform optical film, the deviation of rotation axis of the jig 20 should be kept within 50 μm.

When a high-pressure carrier gas is supplied from the compressor 45 to the nozzle 40, the coating solution 13 is sucked by negative pressure from the tank 41, so that the coating solution 13 is sprayed from the nozzle 40. To form a uniform optical film, the amount of the coating solution 13 ejected is preferably 1-10 mL/minute, the variation of the amount of the coating solution 13 ejected is preferably 0.1 mL/minute or less, and the amount of the carrier gas ejected is preferably 1-10 L/minute. The volume ratio of the coating solution 13 to the carrier gas is preferably 1:100 to 1:10,000, more preferably 1:500 to 1:2,000. Because the amount of the coating solution 13 is extremely smaller than that of the carrier gas, the coating solution 13 uniformly attaches to the lens 1.

The nozzle 40 is preferably disposed such that the coating solution 13 is sprayed vertically to the lens 1. As shown in FIG. 10, a spray diameter SD is set such that the spray of the coating solution 13 sufficiently covers the optically effective portion 1a. The distance D₆ between the nozzle 40 and the lens 1 is preferably larger than the height H₂ of the lens 1. Specifically, the distance D₆ is preferably 10-100 mm.

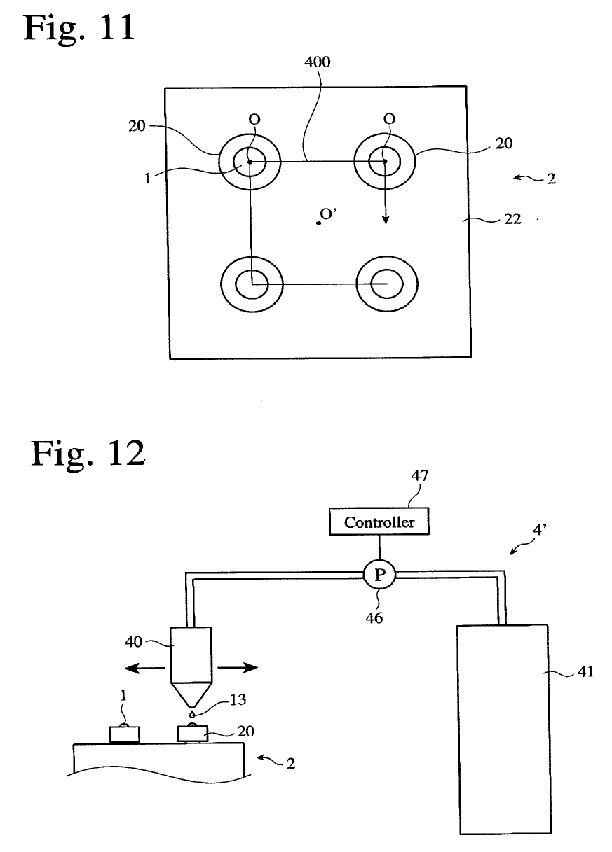

As shown in FIG. 11, when the rotatable jig unit 2 comprises pluralities of (four) jigs 20, to each of which a lens 1 is fixed, the nozzle 40 preferably moves along a square line 400 passing the center O of each lens 1, so that all lenses 1 is uniformly sprayed with the coating solution 13. If the nozzle 40 is stationed above the center O′ of the case 22 to spray the coating solution 13 to all lenses 1 simultaneously, the amount of the coating solution 13 applied to each lens 1 differs between a side closer to the nozzle 40 and a far side, resulting in a non-uniform optical film.

The moving speed of the nozzle 40 is preferably 10-2,000 mm/second, more preferably 10-1,000 mm/second. When the moving speed exceeds 2,000 mm/second, the coating solution 13 is applied to the lens 1 in an insufficient amount. When it is less than 10 mm/second, too much coating solution is applied in one spraying step.

Although an optical film can be formed on the lens 1 even by one spraying step, it is preferable to conduct plural spraying steps to form a more uniform optical film. With the movement of the nozzle 40 called “scanning,” the number of scanning differs depending on the desired optical film thickness, but it is preferably 1-3 times as a practical matter. Such spraying of the coating solution 13 can uniformly apply the coating solution 13 to a lens 1 with a large inclination angle.

(4) Drying and Curing

Because the solvent in the coating solution 13 is volatile, a coating layer on the lens 1 can be spontaneously dried, but it may be heat-dried. The heating temperature is lower than the glass-transition temperature of the lens 1. The resultant optical film may be cured if necessary. For instance, when the coating solution contains heat-curable or ultraviolet-curable resins, a heat treatment or ultraviolet irradiation is conducted.

In the second apparatus in which the coating solution 13 is dropped from the nozzle 40, the rotation speed of the lens 1 (jig 20) is set to 8,000 rpm or more with 50 μm or less of deviation of rotation axis, to form a uniform optical film. One drop of the coating solution 13 in a proper amount is preferably used. The amount of the coating solution 13 ejected by one drop is preferably 0.01-1.0 mL, though variable depending on the size of the lens 1. The coating solution 13 is, of course, dropped onto a center of the lens 1. Because of a dropping system, the nozzle 40 stops above each lens 1.

[4] Optical Article

An optical film having uniform thickness of 1 μm or less is formed on the lens 1 by the above method. A typical example of the optical film is an ant-reflection film. For instance, when an optical film having an average thickness of 100 nm or less is formed on the lens 1 using the first apparatus, the thickness of a portion of the optical film at an inclination angle α of 65° can be 2.5 times or less that of a portion at an inclination angle α of 0°. Also, when an optical film of 100 nm or less is formed on the lens 1 using the second apparatus, the difference between the minimum value and the maximum value in thickness can be within 20 nm in a region with an inclination angle α of 0-65°.

Although the present invention has been explained referring to the drawings, the present invention is not restricted thereto, and various modifications may be added unless they change the technical concept of the present invention.

The present invention will be explained in further detail referring to Example below, though it is not restricted thereto.

### Example 1

### (1) Preparation of Organic-Modified Silica Gel Solution

3.54 g of tetramethoxysilane trimer, 30.33 g of methanol, and 1.92 g of 0.05-N ammonia were mixed by stirring at room temperature for 72 hours, to form wet silica gel. After removing methanol by decantation, ethanol was added to the silica gel and vibrated, and ethanol was removed by decantation. After methyl isobutyl ketone (MIBK) was added to the silica gel and vibrated, MIBK was removed by decantation.

A solution of triethylchlorosilane in MIBK at a concentration of 5% by volume was added to the silica gel, and stirred for 30 hours to organically modify silanol groups. The resultant organic-modified silica gel was washed with MIBK, and then diluted by MIBK to a concentration of 1% by mass. By an ultrasonic treatment at 20 kHz and 500 W for 120 minutes, an organic-modified silica gel solution (sol) having a viscosity of 0.65 cP was obtained.

### (2) Formation of Optical Film

Using the apparatus shown in FIGS. 2-4, a pickup lens 1 having the maximum incident angle of 65°, a diameter D₂ of 4 mm and a height H₂ of 3 mm with an optically effective portion 1a having a diameter of 3 mm was fixed to each jig 20, and the jig 20 was rotated at a constant speed of 10,200 rpm. By a non-contact laser displacement meter comprising a measurement part LC-2430 and a controller LC-2400 available from Keyence Corporation, which was disposed by the jig 20, the displacement of a side surface of the rotating jig 20 was measured three times, and the maximum displacement was regarded as “deviation of rotation axis.” As a result, the deviation of the rotation axis of the jig 20 was 18 μm. Also, the rotation speed precision of the jig 20 was determined by monitoring an output signal from an encoder directly connected to the motor. As a result, the rotation speed precision was ±0.01% or less.

A nozzle 40 spraying the organic-modified silica gel solution (sol) obtained in the step (1) was moved along a square line 400 shown in FIG. 11, to apply the organic-modified silica gel solution to each lens 1. The spraying conditions were as follows:

| | |
|---|---|
| Gas ejection | 6.0 L/minute, |
| Sol ejection | 6.0 mL/minute, |
| Sol ejection variation | 0.1 mL/minute or less, |
| Nozzle-moving speed | 450 mm/second, |
| Lens-nozzle distance | 20 mm, and |
| Spray diameter (SD) | 20 mm. |

After the above coating step was repeated three times, the resultant coating was dried at room temperature to form an optical film of organic-modified silica aerogel. The physical thickness of 10 optical films thus formed was measured at inclination angles α of 0-65° by an optical thickness meter, to determine an average thickness at each inclination angle α. The average thickness and standard deviation are shown in Table 1.

TABLE 1

| | Inclination Angle α | | | | | | | |
|---|---|---|---|---|---|---|---|---|
| | 0° | 10° | 20° | 30° | 40° | 50° | 60° | 65° |
| Average Thickness | 32 | 30 | 32 | 34 | 38 | 49 | 48 | 58 |
| (nm) | | | | | | | | |
| Standard Deviation | 5 | 3 | 9 | 6 | 6 | 9 | 8 | 15 |

The average thickness of a portion at an inclination angle α of 65° was 1.8 times that of a portion at an inclination angle α of 0°, indicating that the optical film had excellent uniformity. Average thickness variation in the inclination angle α of 0-65° was smooth.

### Example 2

An optical film was formed in the same manner as in Example 1 except for changing the rotation speed of the jig 20 to 13,000 rpm. The physical thickness of 10 optical films thus formed was measured at inclination angles α of 0-65° in the same way as above to determine an average thickness at each inclination angle α. The average thickness and standard deviation are shown in Table 2.

TABLE 2

| | Inclination Angle α | | | | | | | |
|---|---|---|---|---|---|---|---|---|
| | 0° | 10° | 20° | 30° | 40° | 50° | 60° | 65° |
| Average Thickness | 27 | 29 | 28 | 36 | 48 | 54 | 51 | 64 |
| (nm) | | | | | | | | |
| Standard Deviation | 6 | 2 | 3 | 6 | 4 | 10 | 10 | 9 |

The average thickness of a portion at an inclination angle α of 65° was 2.4 times that of a portion at an inclination angle α of 0°, indicating that the optical film had excellent uniformity. Average thickness variation in the inclination angle α of 0-65° was smooth.

### Comparative Example 1

An optical film was formed in the same manner as in Example 1 except for using an apparatus in which the deviation of rotation axis of the jig 20 was 120 μm at 10,200 rpm. The physical thickness of 10 optical films thus formed was measured at inclination angles α of 0-65° in the same way as above to determine an average thickness at each inclination angle α. The average thickness and standard deviation are shown in Table 3.

TABLE 3

| | Inclination Angle α | | | | | | | |
|---|---|---|---|---|---|---|---|---|
| | 0° | 10° | 20° | 30° | 40° | 50° | 60° | 65° |
| Average Thickness | 40 | 41 | 42 | 46 | 64 | 78 | 90 | 113 |
| (nm) | | | | | | | | |
| Standard Deviation | 9 | 6 | 7 | 14 | 16 | 8 | 17 | 34 |

The average thickness of a portion at an inclination angle α of 65° was 2.8 times that of a portion at an inclination angle α of 0°, indicating that the optical film had poor uniformity.

### Comparative Example 2

An optical film was formed in the same manner as in Example 1 except for changing the rotation speed of the jig 20 to 2,000 rpm. The physical thickness of 10 optical films thus formed was measured at inclination angles α of 0-65° in the same way as above to determine an average thickness at each inclination angle α. The average thickness and standard deviation are shown in Table 4.

TABLE 4

| | Inclination Angle α | | | | | | | |
|---|---|---|---|---|---|---|---|---|
| | 0° | 10° | 20° | 30° | 40° | 50° | 60° | 65° |
| Average Thickness | 67 | 67 | 88 | 113 | 214 | 279 | 186 | 62 |
| (nm) | | | | | | | | |
| Standard Deviation | 6 | 7 | 28 | 50 | 35 | 51 | 98 | 63 |

The average thickness was maximum at an inclination angle α of 50°, which was 4.2 times that of a portion at an inclination angle α of 0°, and the average thickness drastically decreased in a region within the inclination angle α of 50-65°, indicating that the optical film bad poor uniformity.

### Example 3

Using the coating apparatus 4′ shown in FIG. 12 comprising the jig 20 shown in FIG. 4, 0.02 mL of the same organic-modified silica gel solution as in Example 1 was dropped onto a lens 1 rotating at a constant speed of 10,200 rpm. The dropping conditions and rotation conditions were as follows:

Dropping conditions

| | |
|---|---|
| Sol ejection | 0.02 mL, and |
| Lens-nozzle distance | 20 mm. |

Rotation conditions

| | |
|---|---|
| Rotation speed | 10,200 rpm, |
| Rotation speed precision | ±0.01% or less, and |
| Deviation of rotation axis | 18 μm. |

After repeating the above coating step three times, the resultant coating was dried at room temperature to form an optical film of organic-modified silica aerogel. The physical thickness of 10 optical films thus formed was measured at inclination angles α of 0-65° in the same way as above to determine an average thickness at each inclination angle α. The average thickness and standard deviation are shown in Table 5.

TABLE 5

| | Inclination Angle α | | | | | | | |
|---|---|---|---|---|---|---|---|---|
| | 0° | 10° | 20° | 30° | 40° | 50° | 60° | 65° |
| Average Thickness | 44 | 44 | 46 | 48 | 53 | 51 | 48 | 49 |
| (nm) | | | | | | | | |
| Standard Deviation | 2 | 5 | 2 | 2 | 2 | 5 | 2 | 4 |

The difference between the minimum value and the maximum value in average thickness in a region within the inclination angle α of 0-65° was 9 μm, indicating that the optical film had excellent uniformity.

### Comparative Example 3

An optical film was formed in the same manner as in Example 3 except for using an apparatus in which the deviation of rotation axis of the jig 20 was 120 μm at a rotation speed of 10,200 rpm. The physical thickness of 10 optical films thus formed was measured at inclination angles α of 0-65° in the same way as above to determine an average thickness at each inclination angle α. The average thickness and standard deviation are shown in Table 6.

TABLE 6

| | Inclination Angle α | | | | | | | |
|---|---|---|---|---|---|---|---|---|
| | 0° | 10° | 20° | 30° | 40° | 50° | 60° | 65° |
| Average Thickness | 45 | 40 | 46 | 41 | 80 | 66 | 98 | 124 |
| (nm) | | | | | | | | |
| Standard Deviation | 10 | 5 | 2 | 15 | 9 | 7 | 20 | 36 |

The difference between the minimum value and the maximum value in average thickness in a region within the inclination angle α of 0-65° was 84 μm, indicating that the optical film had poor uniformity.

### Comparative Example 4

An optical film was formed in the same manner as in Example 3 except for changing the rotation speed of the jig 20 to 2,000 rpm. The physical thickness of 10 optical films thus formed was measured at inclination angles α of 0-65° in the same way as above to determine an average thickness at each inclination angle α. The average thickness and standard deviation are shown in Table 7.

TABLE 7

| | Inclination Angle α | | | | | | | |
|---|---|---|---|---|---|---|---|---|
| | 0° | 10° | 20° | 30° | 40° | 50° | 60° | 65° |
| Average Thickness | 70 | 73 | 92 | 109 | 251 | 300 | 160 | 58 |
| (nm) | | | | | | | | |
| Standard Deviation | 5 | 9 | 24 | 48 | 30 | 60 | 100 | 53 |

The difference between the minimum value and the maximum value in average thickness in a region within the inclination angle α of 0-65° was 242 μm, the average thickness of a portion at an inclination angle α of 50° was 4.3 times that of a portion at an inclination angle α of 0°, and the average thickness drastically decreased in a region within the inclination angle α of 50-65°, indicating that the optical film had poor uniformity.

### EFFECT OF THE INVENTION

According to the present invention, an optical film having excellent uniformity can be formed on an optical substrate having a large inclination angle such as a pickup lens at low cost with good reproducibility.

The present disclosure relates to subject matter contained in Japanese Patent Application No. 2006-271063 (filed on Oct. 2, 2006) and Japanese Patent Application No. 2006-271064 (filed on Oct. 2, 2006), which are expressly incorporated herein by reference in their entireties.

What is claimed is:

1. A method for forming an optical film on an optical substrate comprising fixing said optical substrate to a rotatable jig, and spraying or dropping a coating solution containing an optical-film-forming component onto said optical substrate while rotating said jig, the rotation speed of said jig being 8,000 rpm or more, and the deviation of rotation axis of said jig being kept within 50 μm.

2. The method for forming an optical film according to claim 1, wherein the rotation speed precision of said jig is kept within ±0.05%.

3. The method for forming an optical film according to claim 1, wherein using a nozzle communicating to a carrier gas reservoir and a coating solution tank, a high-pressure carrier gas is sent to said nozzle from said carrier gas reservoir to supply said coating solution from said tank to said nozzle by negative-pressure suction, thereby spraying said coating solution from said nozzle.

4. The method for forming an optical film according to claim 3, wherein the amount of said coating solution ejected is 1-10 mL/minute, wherein the variation of the amount of said coating solution ejected is 0.1 mL/minute or less, and wherein the amount of said carrier gas ejected is 1-10 L/minute.

5. The method for forming an optical film according to claim 3, wherein with pluralities of jigs in one unit, said nozzle spraying said coating solution moves along a line passing over all optical substrates.

6. The method for forming an optical film according to claim 5, wherein the moving speed of said nozzle is 10-2,000 mm/second.

7. The method for forming an optical film according to claim 1, wherein said coating solution has such a concentration as to have a viscosity of 20 cP or less.

8. The method for forming an optical film according to claim 1, wherein the step of spraying or dropping said coating solution onto said optical substrate is repeated plural times.

9. The method for forming an optical film according to claim 1, wherein said optical substrate is a pickup lens.

10. An apparatus for forming an optical film on an optical substrate comprising a rotatable jig for fixedly holding said optical substrate, an apparatus for rotating said jig, and a nozzle for spraying or dropping a coating solution containing an optical-film-forming component onto said optical substrate, the rotation speed of said jig being 8,000 rpm or more, and the deviation of rotation axis of said jig being 50 μm or less.

11. The apparatus for forming an optical film according to claim 10, wherein the rotation speed precision of said jig rotating at 8,000 rpm or more is within ±0.05%.

12. An apparatus for forming an optical film on a curved-surface, optically effective portion of a pickup lens having said optically effective portion and a circumferential flange, comprising a rotatable jig for fixedly holding said pickup lens, an apparatus for rotating said jig, a case rotatably supporting said jig, and a nozzle for spraying or dropping a coating solution containing an optical-film-forming component onto said pickup lens;
wherein said jig comprises a columnar table for supporting said pickup lens at a rotation center, and a hollow cylindrical cover attached to said columnar table;
wherein said hollow cylindrical cover comprises a cylindrical portion, and tabs extending inward from an upper end of said cylindrical portion for fixedly holding said flange; and
wherein said coating solution is sprayed or dropped onto said optically effective portion, while rotating said jig at a rotation speed of 8,000 rpm or more with the deviation of rotation axis of 50 μm or less.

13. The apparatus for forming an optical film according to claim 12, wherein said jig comprises a doughnut-shaped plate between said flange and said tabs.

14. The apparatus for forming an optical film according to claim 12, wherein said hollow cylindrical cover is screwed to said columnar table.

15. The apparatus for forming an optical film according to claim 12, wherein said case rotatably supports pluralities of jigs, and wherein the apparatus comprises an apparatus for moving said nozzle over all pickup lenses.

16. An optical article having the optical film formed by the method recited in claim 1.
